(19) United States
(12) Patent Application Publication
(10) Pub. No.: US 2021/0300768 A1
(43) Pub. Date: Sep. 30, 2021

(54) METHOD FOR PRODUCING SI-BASED ACTIVE MATERIAL

(71) Applicant: TOYOTA JIDOSHA KABUSHIKI KAISHA, Toyota-shi (JP)

(72) Inventors: Jun YOSHIDA, Mishima-shi (JP); Kazuhiro SUZUKI, Hadano-shi (JP); Mitsutoshi OTAKI, Susono-shi (JP)

(73) Assignee: TOYOTA JIDOSHA KABUSHIKI KAISHA, Toyota-shi (JP)

(21) Appl. No.: 17/201,788

(22) Filed: Mar. 15, 2021

(30) Foreign Application Priority Data
Mar. 24, 2020 (JP) 2020-052316

(51) Int. Cl. C01B 33/021

(52) U.S. Cl. CPC C01B 33/021; C01P 2002/90

(57) ABSTRACT

A method produces a Si-based active material containing a Si-based clathrate compound decreasing a Na element content while maintaining a crystal phase of type II clathrate. The method that produces a Si-based active material containing a Si-based clathrate compound having a crystal phase of type II clathrate, includes: preparing the Si-based clathrate compound by heating an alloy containing a Na element and a Si element at a temperature of 340° C. or more and less than 400° C. (a first heating step), heating the Si-based clathrate compound at a temperature of 340° C. or more and less than 470° C. after the first heating step (a second heating step), cooling the Si-based clathrate compound to a temperature of less than 340° C. after the second heating step (a cooling step), and heating the Si-based clathrate compound at a temperature of 340° C. or more and less than 470° C. after the cooling step (a third heating step).

### TECHNICAL FIELD

The disclosure relates to a method for producing a Si-based active material.

### BACKGROUND

In recent years, battery development has been actively pursued. For example, in the automobile industry, the development of batteries for use in electric or hybrid vehicles has been pursued. Silicon (hereinafter may be referred to as Si) particles are known as an active material for use in batteries.

A method for producing a Si clathrate is disclosed in Patent Literature 1, the method comprising, although it is not an invention relating to batteries, a positive-pressure heating step of heating a mixture of a silicon wafer and Na at a temperature of 650° C. or more to form a compound comprising Si and Na, and a negative-pressure heating step of heating the compound comprising Si and Na formed in the positive-pressure heating step at a temperature of 300° C. or more and 450° C. or less for one hour or more under a negative pressure of 10⁻² Pa or less.

Patent Literature 2 discloses a method for producing a type-II Si-based clathrate including Na, the method comprising a positive-pressure heating step of heating a mixture of Si powder, Ge powder and Na at a temperature of 650° C. or more to form a compound comprising Si, Ge and Na, and a negative-pressure heating step of heating the compound comprising Si, Ge and Na formed in the positive pressure heating step under a negative pressure of 10⁻² Pa or less at a temperature of 300° C. or more and 450° C. or less for two hours or more and 72 hours or less.
Patent Literature 1: Japanese Patent Application Laid-Open (JP-A) No. 2012-224488
Patent Literature 2: JP-A No. 2013-018679

Si particles have a large theoretical capacity and are effective in obtaining a battery with high energy density. On the other hand, Si particles undergo a large volume change during charge and discharge. Accordingly, there is a demand for a Si-based active material configured to undergo a small volume change during charge and discharge. Especially, there is a high demand for a Si-based active material configured to exhibit suppressed expansion during the insertion of metal ions such as Li ions.

Depending on conditions, the production method of Patent Literature 2 has the following problem: since the content of the Na element in the Si-based clathrate compound is large, when the Si-based clathrate compound is used as an active material, its expansion is not sufficiently suppressed during the insertion of metal ions.

### SUMMARY

The disclosed embodiments were achieved in light of the above circumstances. An object of the disclosed embodiments is to provide a method for producing a Si-based active material containing a Si-based clathrate compound configured to decrease the content of a Na element while maintaining a crystal phase of type II clathrate.

In a first embodiment, there is provided a method for producing a Si-based active material containing a Si-based clathrate compound having a crystal phase of type II clathrate,

the method comprising:

preparing the Si-based clathrate compound by heating an alloy containing a Na element and a Si element at a temperature of 340° C. or more and less than 400° C. (a first heating step),

heating the Si-based clathrate compound at a temperature of 340° C. or more and less than 470° C. after the first heating step (a second heating step),

cooling the Si-based clathrate compound to a temperature of less than 340° C. after the second heating step (a cooling step), and

heating the Si-based clathrate compound at a temperature of 340° C. or more and less than 470° C. after the cooling step (a third heating step).

In the third heating step, the Si-based clathrate compound may be heated at a temperature of 340° C. or more and less than 470° C., in combination with SiO.

The heating temperature of the first heating step may be 340° C. or more and 395° C. or less.

A content of the Na element in the alloy may be 0.8 mol or more and 1.5 mol or less, with respect to 1 mol of the Si element.

A heating time of the first heating step may be 14 hours or less.

A heating time of the second heating step may be 6 hours or less.

A heating time of the third heating step may be 16 hours or less.

According to the disclosed embodiments, a method for producing a Si-based active material containing a Si-based clathrate compound configured to decrease the content of a Na element while maintaining a crystal phase of type II clathrate, can be provided.

### DETAILED DESCRIPTION

The disclosed embodiments provide a method for producing a Si-based active material containing a Si-based clathrate compound having a crystal phase of type II clathrate,

the method comprising:

preparing the Si-based clathrate compound by heating an alloy containing a Na element and a Si element at a temperature of 340° C. or more and less than 400° C. (a first heating step),

heating the Si-based clathrate compound at a temperature of 340° C. or more and less than 470° C. after the first heating step (a second heating step),

cooling the Si-based clathrate compound to a temperature of less than 340° C. after the second heating step (a cooling step), and

heating the Si-based clathrate compound at a temperature of 340° C. or more and less than 470° C. after the cooling step (a third heating step).

A clathrate compound having a clathrate-type crystal phase is a compound in which guest atoms are present in a three-dimensional cage structure that is formed by host atoms.

In the disclosed embodiments, a clathrate compound in which a Si element is present as host atoms is referred to as “Si clathrate compound”, and a clathrate compound in which a Si element of more than 50% in mol is present as host atoms, is referred to as “Si-based clathrate compound”.

Si-based clathrate compounds are classified into type I to VIII clathrates, depending on differences in their three-dimensional structures. Si-based clathrate compounds in which a sodium (hereinafter may be referred to as Na) element is present as guest atoms and a Si element is present as host atoms, are mainly classified into the following two types of compounds: a compound having a crystal phase of type I clathrate and a compound having a crystal phase of type II clathrate.

The Si clathrate compound having the crystal phase of type I clathrate, has a cubic structure composed of Si₂₀ (a dodecahedral structure) and Si₂₄ (a tetradecahedral structure). The Si clathrate compound having the crystal phase of type II clathrate, has a cubic structure composed of Si₂₀ (a dodecahedral structure) and Si₂₈ (a hexadecahedral structure).

Metal ions such as Li ions can enter the three-dimensional cage structure of the Si-based clathrate compound. Even when metal ions enter the structure of the Si-based clathrate compound, the expansion amount of the Si-based clathrate compound is small, and the volume change associated with battery charge and discharge is small.

When the Na element remains in the Si-based clathrate compound having the crystal phase of type II clathrate (hereinafter, it may be referred to as “Si-based clathrate compound (type II)”), since the remaining Na element is likely to be present in the cage structure that serves to suppress expansion and contraction, there is the following problem: due to the remaining Na element, expansion and contraction associated with battery charge and discharge cannot be suppressed.

Compared to the Si-based clathrate compound having the crystal phase of type I clathrate (hereinafter, it may be referred to as “Si-based clathrate compound (type I)”), the Si-based clathrate compound (type II) can easily eliminate the Na element after its production. However, conventional methods for producing the Si-based clathrate compound (type II) have the following problem: sufficient amounts of the Na element cannot be eliminated depending on the heating condition, and it takes a long time to eliminate sufficient amounts of the Na element.

As a result of research, a heating condition in which the Na element can be more eliminated from the Si-based clathrate compound (type II) for a shorter time than before, was found.

The method for producing the Si-based active material according to the disclosed embodiments, comprises at least (1) the first heating step, (2) the second heating step, (3) the cooling step and (4) the third heating step.

### (1) First Heating Step

The first heating step is a step of preparing the Si-based clathrate compound by heating an alloy containing a Na element and a Si element at a temperature of 340° C. or more and less than 400° C.

### (1-1) Production of Alloy

The method for producing the alloy is not particularly limited. As the production method, examples include, but are not limited to, heating a mixture containing Si particles, an elemental Na and, as needed, an elemental M (a metal M).

The mixture heating temperature is 500° C. or more and 1000° C. or less, for example.

The mixture heating time is one hour or more and 50 hours or less, for example.

Pressure is applied to the mixture during the heating. The applied pressure is not particularly limited and is 100 Pa or less, for example. It may be 10 Pa or less, may be 1 Pa or less, or may be 0.1 Pa or less.

The atmosphere of the alloy production may be an Ar atmosphere, for example.

The particle diameter, purity, form, specific surface area, etc., of the Si particles, elemental Na and elemental M are not particularly limited. For example, their particle diameters may be from 1 nm to 5 μm.

The M element contained in the elemental M may be a metal element, or it may be a metal element having a larger ionic radius than the Si element. Since the Si element generally has a tetravalent ionic radius of 0.40 Å, the ionic radius of the M element may be more than 0.40 Å. For example, the ionic radius of the M element may be more than 0.40 Å, may be 0.41 Å or more, may be more than 0.41 Å, or may be 0.50 Å or more. On the other hand, the ionic radius of the M element may be 0.70 Å or less, or it may be 0.65 Å or less, for example. The ionic radius of the M element may be close to the ionic radius of the Si element.

For the period or group of the periodic table, the M element may be close to the Si element. As the M element, examples include, but are not limited to, an Al element (ionic radius: 0.535 Å), a Ga element (ionic radius: 0.62 Å) and a Ge element (ionic radius: 0.53 Å). In the disclosed embodiments, the M element may be a Ga element or a Ge element, and it may be a Ge element. As the elemental M, one kind of element or two or more kinds of elements may be used.

The molar ratio of the Si element, Na element and M element in the alloy is not particularly limited.

With respect to 1 mol of the Si element, the Na element is 0.8 mol or more, for example. It may be 1 mol or more, or it may be 1.1 mol or more. On the other hand, with respect to 1 mol of the Si element, the Na element is 1.5 mol or less, for example. It may be 1.3 mol or less, or it may be 1.2 mol or less.

With respect to the total (100 mol) of the Si element and the M element, the M element is 0 mol or more, for example. It may be 0.1 mol or more, or it may be 0.4 mol or more. On the other hand, with respect to the total (100 mol) of the Si element and the M element, the M element is 5.0 mol or less, for example. It may be 1.0 mol or less.

When the M element is contained in the alloy, with respect to the total (1 mol) of the Si element and the M element, the Na element is 0.8 mol or more, for example. It may be 1 mol or more, or it may be 1.1 mol or more. On the other hand, with respect to the total (1 mol) of the Si element and the M element, the Na element is 1.5 mol or less, for example. It may be 1.3 mol or less, or it may be 1.2 mol or less.

### (1-2) Preparation of Si-Based Clathrate Compound (Type II)

The heating temperature of the first heating step is 340° C. or more. On the other hand, the heating temperature of the first heating step is less than 400° C., and from the viewpoint of the ease of forming the Si-based clathrate compound (type II), the heating temperature may be 395° C. or less, may be 390° C. or less, or may be 385° C. or less. When the heating temperature is less than 340° C., the Si-based clathrate compound (type II) cannot be easily formed. When the heating temperature is 400° C. or more, the Si-based clathrate compound (type I) can be easily formed.

The heating time of the first heating step may be one hour or more, may be 4 hours or more, or may be 10 hours or more, for example. On the other hand, the heating time may be 20 hours or less, or it may be 14 hours or less, for example.

In the first heating step, pressure is applied during the heating. The applied pressure is 100 Pa or less, for example. It may be 10 Pa or less, may be 1 Pa or less, may be 0.1 Pa or less, or may be 0.01 Pa or less.

The heating atmosphere of the first heating step may be an Ar atmosphere, for example.

In general, the Si-based clathrate compound (type II) obtained in the first heating step belongs to the space group (Fd-3m). The Si-based clathrate compound (type II) contains the Na element and the Si element. As needed, it further contains the M element.

With respect to the total of the Si element and M element in the Si-based clathrate compound (type II), the ratio of the M element may be 0 mass % or more, may be 0.1 mass % or more, may be 0.5 mass % or more, or may be 1 mass % or more, for example. On the other hand, the ratio of the M element may be 10 mass % or less, may be 5 mass % or less, or may be 3 mass % or less, for example. The ratio of the M element can be measured by energy dispersive X-ray spectroscopy (EDX), X-ray fluorescence spectrometry (XRF) or X-ray photoelectron spectroscopy (XPS), for example.

The Si-based clathrate compound (type II) may contain the M element as framework atoms. In this case, the Si-based clathrate compound (type II) can be deemed as the Si-based clathrate compound in which a part of the Si element serving as the framework atoms, is substituted with the M element, with respect to the Si clathrate compound in which only the Si element is contained as framework atoms. With respect to the Si element, the M element can be deemed as a different element. In the Si-based clathrate compound (type II) of the disclosed embodiments, the M element is contained as the framework atoms. Also, the M element may be contained as guest atoms.

As needed, the Si-based clathrate compound (type II) may further contain a M² element, which is a metal element other than the Na element and the M element.

As the M² element, examples include, but are not limited to, a Li element, a K element, a Rb element and a Cs element. As the M² element, examples also include a Mg element, a Ca element, a Sr element and a Ba element. As the M² element, examples further include a Group 11 element such as a Cu element, an Ag element and an Au element; a Group 12 element such as a Zn element; a Group 13 element such as a B element, an In element and a Tl element; a Group 15 element such as a Sb element; a Group 16 element such as a Te element; and a lanthanoid such as a La element and an Eu element. As the M² element, examples also include a transition metal element such as a Ni element.

The presence or absence of the crystal phase of type II clathrate in the Si-based clathrate compound can be determined by checking, by X-ray diffractometry using CuKα radiation, whether or not peaks are present in the positions of 20=20.09°, 21.00°, 26.51°, 31.72°, 36.26° and 53.01°. The peak positions may fall within a range of plus or minus 1.00°, 0.50° or 0.30° of 20.09°, 21.00°, 26.51°, 31.72°, 36.26° and 53.01°. When a metal ion such as a lithium ion is inserted into the Si-based clathrate compound (type II), a peak shift may occur. Accordingly, the XRD may be carried out when a metal ion is not inserted into the compound.

The form of the Si-based clathrate compound (type II) is not particularly limited. It may be a particulate form.

The Si-based clathrate compound (type II) obtained in the first heating step may be a compound represented by the general formula NaₓM_{y}Si_{136-y} (where 8.00≤x≤24.00 and 0≤y≤5), for example. In the general formula NaₓM_{y}Si_{136-y}, x may satisfy 10.00≤x<22.00.

### (2) Second Heating Step

The second heating step is a step of heating the Si-based clathrate compound at a temperature of 340° C. or more and less than 470° C. after the first heating step.

A predetermined amount of the Na element can be eliminated from the Si-based clathrate compound (type II) by the second heating step.

The Si-based clathrate compound (type II) obtained in the second heating step may be a compound represented by the general formula NaₓM_{y}Si_{136-y} (where 6.00≤x≤15.00 and 0≤y≤5), for example. In the general formula NaₓM_{y}Si_{136-y}, x may satisfy 8.00≤x<10.00.

The heating temperature of the second heating step is 340° C. or more. The heating temperature may be 350° C. or more, or it may be 430° C. or more. On the other hand, the heating temperature is less than 470° C., or it may be 450° C. or less. When the heating temperature is less than 340° C., it may be difficult to eliminate the Na element from the Si-based clathrate compound (type II). When the heating temperature is 470° C. or more, a Si-based compound having a diamond-type crystal phase may be easily formed.

The heating time of the second heating step is 30 minutes or more, for example. The heating time may be one hour or more, or it may be 4 hours or more. On the other hand, the heating time may be 20 hours or less, may be 14 hours or less, may be 10 hours or less, or may be 6 hours or less, for example.

In the second heating step, pressure is applied during the heating. The applied pressure is 100 Pa or less, for example. It may be 10 Pa or less, may be 1 Pa or less, may be 0.1 Pa or less, or may be 0.01 Pa or less.

The heating atmosphere of the second heating step may be an Ar atmosphere, for example.

### (3) Cooling Step

The cooling step is a step of cooling the Si-based clathrate compound to a temperature of less than 340° C. after the second heating step.

It is estimated that by the cooling step, the type II crystal phase of the Si-based clathrate compound can be stabilized, and the Na element that is unevenly present inside the particles of the Si-based clathrate compound (type II) subjected to the second heating step, can be uniformly disposed on the surface and inside of the particles.

The cooling temperature is less than 340° C. It may be room temperature (25° C.) or less.

The method for cooling the Si-based clathrate compound (type II) is not particularly limited. For example, the Si-based clathrate compound (type II) may be left to cool down in the normal temperature system, or it may be cooled or quenched by use of a cooling device.

The cooling atmosphere of the cooling step may be an Ar atmosphere, for example.

### (4) Third Heating Step

The third heating step is a step of heating the Si-based clathrate compound at a temperature of 340° C. or more and less than 470° C. after the cooling step.

It is thought that in the cooling step, the Na element diffuses inside the particles to promote the uniform distribution of the Na element on the surface and inside of the particles. Then, it is estimated that by the third heating step, a predetermined amount of the Na element can be eliminated from the surface of the particles of the Si-based clathrate compound (type II) in which the Na element is estimated to be uniformly disposed on the surface and inside of the particles after the cooling step. When the same amount of Na is tried to be eliminated in the second heating step without carrying out the cooling step, while the Na element present on the surface of the particles of the Si-based clathrate compound (type II) can be easily eliminated in the second heating step, the Na element present inside the particles cannot be easily eliminated. Accordingly, after the predetermined amount of the Na element is eliminated from the surface of the particles, it takes a long time to eliminate a desired amount of the Na element. Accordingly, it is thought that by carrying out the cooling step after the predetermined amount of the Na element is eliminated and then carrying out the third heating step, a desired amount of the Na element can be eliminated from the Si-based clathrate compound (type II) for a short time compared to the case of not carrying out the cooling step.

The Si-based clathrate compound (type II) obtained in the third heating step may be a compound represented by the general formula NaₓM_{y}Si_{136-y} (where 4.00≤x<8.00 and 0≤y≤5), for example. In the general formula NaₓM_{y}Si_{136-y}, x may satisfy 4.00≤x<6.00.

The heating temperature of the third heating step is 340° C. or more. The heating temperature may be 350° C. or more, or it may be 430° C. or more. On the other hand, the heating temperature is less than 470° C., or it may be 450° C. or less. When the heating temperature is less than 340° C., it may be difficult to eliminate the Na element from the Si-based clathrate compound (type II). When the heating temperature is 470° C. or more, a Si-based compound having a diamond-type crystal phase may be easily formed.

The heating time of the third heating step is 30 minutes or more, for example, or it may be one hour or more. On the other hand, the heating time may be 20 hours or less, or it may be 16 hours or less, for example.

In the third heating step, pressure is applied during the heating. The applied pressure is 100 Pa or less, for example. It may be 10 Pa or less, may be 1 Pa or less, may be 0.1 Pa or less, or may be 0.01 Pa or less.

The heating atmosphere of the third heating step may be an Ar atmosphere, for example.

In the third heating step, the Si-based clathrate compound (type II) may be heated in combination with SiO, from the viewpoint of the ease of eliminating the Na element from the Si-based clathrate compound (type II).

In the second heating step, the Si-based clathrate compound (type II) may be heated in combination with SiO.

The amount of the SiO used in the third heating step is not particularly limited. For example, the molar ratio (SiO/Si element) of the SiO to the Si element in the Si-based clathrate compound (type II) may be 0.01 or more, may be 0.03 or more, may be 0.1 or more, may be 0.4 or less, or may be 0.3 or less.

The Si-based active material obtained by the production method of the disclosed embodiments contains the Si-based clathrate compound (type II). In the disclosed embodiments, as long as the Si-based active material contains the Si-based clathrate compound (type II), the Si-based active material may also contain the Si-based clathrate compound (type I), the Si-based compound having the diamond-type crystal phase, etc.

In general, the Si-based active material obtained by the production method of the disclosed embodiments is used in batteries. The Si-based active material of the disclosed embodiments may be an anode active material or a cathode active material. The Si-based active material may be the former.

According to the disclosed embodiments, for example, a battery comprising a cathode layer, an electrolyte layer and an anode layer in this order in the thickness direction, in which the anode layer contains the above-described Si-based active material, can be provided.

The battery of the disclosed embodiments is a battery in which metal ions conduct between the cathode layer and the anode layer. As such a battery, examples include, but are not limited to, a lithium ion battery, a sodium ion battery, a potassium ion battery, a magnesium ion battery and a calcium ion battery. Also, the battery of the disclosed embodiments may be a liquid battery in which the electrolyte layer contains a liquid electrolyte, or it may be an all-solid-state battery in which the electrolyte layer contains a solid electrolyte. Also, the battery of the disclosed embodiments may be a primary battery or a secondary battery. The battery of the disclosed embodiments may be a secondary battery, because it can be repeatedly charged and discharged and is useful as a car battery, for example.

The present disclosure is not limited to the above-mentioned embodiments. The above-mentioned embodiments are examples, and any that has the substantially same essential features as the technical ideas described in the claims of the present disclosure and exerts the same effects and advantages as the embodiments is included in the technical scope of the present disclosure.

### EXAMPLES

### Example 1

### [Production of Alloy]

Si particles (purity 99.999%), an elemental Ge and a metal Na (purity 99.5%) were prepared and mixed to obtain a mixture. The mixture was put in a boron nitride crucible, and the crucible was hermetically closed in an Ar atmosphere. The Si particles and the metal Na were weighed out so that the Si particles and the metal Na in the mixture were contained at a molar ratio of 1:1. Also in the mixture, with respect to the total of the Si particles and the elemental Ge, the elemental Ge was about 1 mass % (that is, the elemental Ge was weighed out so that with respect to the total (100 mol) of the Si particles and the elemental Ge, 0.4 mol of the elemental Ge was contained in the mixture). Then, the mixture was heated at a temperature of 700° C. for 20 hours, thereby obtaining a NaGeSi alloy.

### [First Heating Step]

The obtained NaGeSi alloy was heated in vacuum (about 0.01 Pa) at 385° C. for 14 hours in the boron nitride crucible, thereby preparing a Si-based clathrate compound (type II).

The formation of the Si-based clathrate compound (type II) was confirmed by X-ray diffractometry (XRD) using CuKα radiation. The content of the Si element in the Si-based clathrate compound (type II) was about 136 mol.

### [Second Heating Step]

Next, the prepared Si-based clathrate compound (type II) was heated in vacuum (about 0.01 Pa) at 450° C. for 6 hours in the boron nitride crucible, thereby eliminating the Na element from the Si-based clathrate compound (type II).

### [Cooling Step]

Then, the Si-based clathrate compound (type II) was cooled to room temperature (25° C.)

### [Third Heating Step]

Then, SiO was added to the cooled Si-based clathrate compound (type II) so that the Si element and SiO in the Si-based clathrate compound (type II) was at a molar ratio of 1:0.3, thereby obtaining a mixture. The mixture was heated in vacuum (about 0.01 Pa) at 450° C. for 16 hours in the boron nitride crucible, thereby further eliminating the Na element from the Si-based clathrate compound (type II). Accordingly, a Si-based active material containing the Si-based clathrate compound (type II) was produced. The content (mol) of the Na element in the Si-based clathrate compound (type II) of the Si-based active material, is shown in Table 1.

### Example 2

A Si-based active material was produced in the same manner as Example 1, except that the heating temperature of the first heating step was changed to 340° C. The content (mol) of the Na element in the Si-based clathrate compound (type II) of the Si-based active material, is shown in Table 1.

### Example 3

A Si-based active material was produced in the same manner as Example 1, except that the heating temperature of the first heating step was changed to 340° C., and SiO was not added in the third heating step. The content (mol) of the Na element in the Si-based clathrate compound (type II) of the Si-based active material, is shown in Table 1.

### Example 4

A Si-based active material was produced in the same manner as Example 1, except that the heating temperature of the first heating step was changed to 390° C. The content (mol) of the Na element in the Si-based clathrate compound (type II) of the Si-based active material, is shown in Table 1.

### Example 5

A Si-based active material was produced in the same manner as Example 1, except that the heating temperature of the first heating step was changed to 395° C. The content (mol) of the Na element in the Si-based clathrate compound (type II) of the Si-based active material, is shown in Table 1.

### Comparative Example 1

A Si-based active material was produced in the same manner as Example 1, except that the second heating step, the cooling step and the third heating step were not carried out. The content (mol) of the Na element in the Si-based clathrate compound (type II) of the Si-based active material, is shown in Table 1.

### Comparative Example 2

A Si-based active material was produced in the same manner as Example 1, except that the cooling step and the third heating step were not carried out. The content (mol) of the Na element in the Si-based clathrate compound (type II) of the Si-based active material, is shown in Table 1.

### Comparative Example 3

A Si-based active material was produced in the same manner as Example 1, except that the heating time of the second heating step was changed to 48 hours, and the cooling step and the third heating step were not carried out. The content (mol) of the Na element in the Si-based clathrate compound (type II) of the Si-based active material, is shown in Table 1.

### Comparative Example 4

A Si-based active material was produced in the same manner as Example 1, except that the heating temperature of the first heating step was changed to 340° C.; the heating time of the second heating step was changed to 22 hours; and the cooling step and the third heating step were not carried out. The content (mol) of the Na element in the Si-based clathrate compound (type II) of the Si-based active material, is shown in Table 1.

### Comparative Example 5

A Si-based active material was produced in the same manner as Comparative Example 4, except that in the second heating step, the volume of the boron nitride crucible used for heating was increased, and the partial pressures of the gases in the crucible were decreased. The content (mol) of the Na element in the Si-based clathrate compound (type II) of the Si-based active material, is shown in Table 1.

TABLE 1

| | First heating step | | Second heating step | | Third heating step | | | |
|---|---|---|---|---|---|---|---|---|
| | Temperature | Time | Temperature | Time | Temperature | Time | | Na |
| | (C. °) | (hour) | (C. °) | (hour) | (C. °) | (hour) | SiO | (mol) |
| Comparative | 385 | 14 | — | — | — | — | Not | 21.90 |
| Example 1 | | | | | | | present | |
| Comparative | 385 | 14 | 450 | 6 | — | — | Not | 8.22 |
| Example 2 | | | | | | | present | |
| Comparative | 385 | 14 | 450 | 48 | — | — | Not | 5.99 |
| Example 3 | | | | | | | present | |
| Example 1 | 385 | 14 | 450 | 6 | 450 | 16 | Present | 5.23 |
| Example 2 | 340 | 14 | 450 | 6 | 450 | 16 | Present | 5.65 |
| Example 3 | 340 | 14 | 450 | 6 | 450 | 16 | Not | 6.50 |
| | | | | | | | present | |
| Example 4 | 390 | 14 | 450 | 6 | 450 | 16 | Present | 5.81 |
| Example 5 | 395 | 14 | 450 | 6 | 450 | 16 | Present | 7.83 |
| Comparative | 340 | 14 | 450 | 22 | — | — | Not | 6.16 |
| Example 4 | | | | | | | present | |
| Comparative | 340 | 14 | 450 | 22 | — | — | Not | 7.71 |
| Example 5 | | | | | | | present | |

According to a comparison between Comparative Examples 1 and 2, while a certain amount of the Na element can be eliminated from the Si-based clathrate compound (type II) by carrying out the second heating step, the amount of the Na element remaining in the Si-based clathrate compound (type II) is 8 mol or more, and the amount of the eliminated Na element is not sufficient.

From a comparison between Comparative Example 2 and Example 1, the following was proved: the Na element can be further eliminated from the Si-based clathrate compound (type II) by carrying out the cooling step and the third heating step, compared to the case of not carrying out these steps.

From a comparison between Comparative Example 3 and Example 1, the following was proved: as shown by the results of Comparative Example 3, while a certain amount of the Na element can be eliminated from the Si-based clathrate compound (type II) by increasing the heating time of the second heating step, the amount of the Na element eliminated from the Si-based clathrate compound (type II) can be more increased by carrying out the third heating step after the cooling step.

From a comparison between Examples 1 and 2, the following was proved: even when the heating temperature of the first heating step is 340° C., a desired amount of the Na element can be eliminated from the Si-based clathrate compound (type II) by carrying out the subsequent steps.

From a comparison between Examples 2 and 3, the following was proved: the Na element can be more eliminated from the Si-based clathrate compound (type II) by adding SiO and heating the Si-based clathrate compound (type II) in the third heating step.

From a comparison between Comparative Example 2 and Examples 1, 4 and 5, the following was proved: when the heating temperature of the first heating step was changed to 390° C. to 395° C., compared to the case of Example 1, the amount of the Na element eliminated from the Si-based clathrate compound (type II) is small; however, compared to the case of Comparative Example 2, since the amount of the Na element eliminated from the Si-based clathrate compound (type II) is large, a desired amount of the Na element can be eliminated.

From a comparison between Comparative Examples 4 and 5, the following was proved: for the case of Comparative Example 4 in which, in the second heating step, the volume of the crucible is small and the partial pressures of the gases in the crucible are large, the amount of the Na element remaining in the Si-based clathrate compound (type II) is smaller than the case of Comparative Example 5 in which the partial pressures are small; therefore, the amount of the Na element eliminated from the Si-based clathrate compound (type II) does not increase even when the partial pressures are small. In the production method of the disclosed embodiments, accordingly, the amount of the Na element eliminated from the Si-based clathrate compound (type II) is not influenced by the partial pressures of the gases in the crucible.

From the above results, the following was proved: according to the production method of the disclosed embodiments, the Na element is more eliminated from the Si-based clathrate compound (type II) for a shorter time than before.

1. A method for producing a Si-based active material containing a Si-based clathrate compound having a crystal phase of type II clathrate,
the method comprising:
preparing the Si-based clathrate compound by heating an alloy containing a Na element and a Si element at a temperature of 340° C. or more and less than 400° C. (a first heating step),
heating the Si-based clathrate compound at a temperature of 340° C. or more and less than 470° C. after the first heating step (a second heating step),
cooling the Si-based clathrate compound to a temperature of less than 340° C. after the second heating step (a cooling step), and
heating the Si-based clathrate compound at a temperature of 340° C. or more and less than 470° C. after the cooling step (a third heating step).

2. The method for producing the Si-based active material according to claim 1, wherein, in the third heating step, the Si-based clathrate compound is heated at a temperature of 340° C. or more and less than 470° C., in combination with SiO.

3. The method for producing the Si-based active material according to claim 1, wherein the heating temperature of the first heating step is 340° C. or more and 395° C. or less.

4. The method for producing the Si-based active material according to claim 1, wherein a content of the Na element in the alloy is 0.8 mol or more and 1.5 mol or less, with respect to 1 mol of the Si element.

5. The method for producing the Si-based active material according to claim 1, wherein a heating time of the first heating step is 14 hours or less.

6. The method for producing the Si-based active material according to claim 1, wherein a heating time of the second heating step is 6 hours or less.

7. The method for producing the Si-based active material according to claim 1, wherein a heating time of the third heating step is 16 hours or less.
